(19) United States
(12) Patent Application Publication
(10) Pub. No.: US 2015/0106265 A1
(43) Pub. Date: Apr. 16, 2015

(54) SYSTEM AND METHODS FOR PROCESSING A COMMUNICATION NUMBER FOR FRAUD PREVENTION

(71) Applicant: TeleSign Corporation, Marina Del Rey, CA (US)

(72) Inventors: Stacy Lyn Stubblefield, Marina del Rey, CA (US); James Monaghan, London (GB); Marko Dukanac, Belgrade (RS)

(73) Assignee: TeleSign Corporation, Marina Del Rey, CA (US)

(21) Appl. No.: 14/091,242

(22) Filed: Nov. 26, 2013

Related U.S. Application Data
(60) Provisional application No. 61/890,142, filed on Oct. 11, 2013.

(51) Int. Cl. G06Q 50/26; G06Q 20/40

(52) U.S. Cl. CPC G06Q 50/265; G06Q 20/4016
USPC 705/44; 705/325

(57) ABSTRACT

A communication number processing system and methods for processing communication numbers or identifiers of various types to prevent fraud in transactions associated with the communication numbers are disclosed. The communication number processing system, in an example embodiment, verifies a communication number by retrieving characteristics data including network-derived characteristics data and/or other attributes relating to the communication number and processing the characteristics data and/or the attributes based on one or more rules. The communication number processing system further generates a fraud score for the communication number. A client system can then use the fraud score to assess a risk associated with engaging in a transaction with a user associated with the communication number.

### CROSS-REFERENCE TO RELATED APPLICATION(S)

This application claims priority to and benefit from U.S. Provisional Patent Application Ser. No. 61/890,142 entitled “SYSTEM AND METHODS FOR PERFORMING AUTHENTICATION, FRAUD OR RISK ASSESSMENT OF A MOBILE DEVICE USING NETWORK DATA” (Attorney Docket No. 82797-8007.US00) filed on Oct. 11, 2013, which is herein expressly incorporated by reference in its entirety.

This application is also related to U.S. patent application Ser. No. 13/706,261 entitled “FRICTIONLESS MULTI-FACTOR AUTHENTICATION SYSTEM AND METHOD” (Attorney Docket No. 82797.8005.US00) filed on Dec. 5, 2012 and U.S. patent application Ser. No. 13/844,417 entitled “SYSTEM AND METHOD FOR UTILIZING BEHAVIORAL CHARACTERISTICS IN AUTHENTICATION AND FRAUD PREVENTION” (Attorney Docket No. 82797-8006.US00) filed on Mar. 15, 2013. Each of the aforementioned applications is herein expressly incorporated by reference in its entirety.

### BACKGROUND

Internet users regularly supply or are required to supply telephone numbers along with other personally-identifying information when signing up to create accounts with websites or other online service providers (each hereinafter “websites”). The websites utilize the telephone numbers for communication, account verification and in some cases transaction verification. For example, some banking websites send a short message service (SMS) message including a verification code or temporary password to a customer's mobile phone, which is utilized by the customer to authorize a transaction. Some websites integrate telephone number verification in online sign-up forms to prevent fraudulent activities such as creation of multiple accounts or to discourage users from providing invalid or incorrect telephone numbers. Other websites use telephone number verification services to validate customer telephone numbers stored in their databases to ensure that the customer telephone numbers are still in use. These types of verification services are generally limited and provide only a basic layer of protection for customers and websites. As the sophistication of fraudsters increases, the protection afforded by these types of verification services becomes increasingly inadequate. As a result, enhanced verification methods are needed for assessing fraud, and using such fraud assessment for account verification, customer authentication, and transaction verification.

Overall, the examples herein of some prior or related systems and their associated limitations are intended to be illustrative and not exclusive. Other limitations of existing or prior systems will become apparent to those of skill in the art upon reading the following Detailed Description.

### BRIEF DESCRIPTION OF THE DRAWINGS

FIG. 1 is a diagram illustrating an exemplary environment in which a communication number may be processed for fraud prevention.

FIG. 2A is a block diagram illustrating a communication number processing system.

FIG. 2B is a data flow diagram illustrating a feedback process implemented by the communication number processing system to evaluate fraud by generating a fraud score.

FIG. 3 is a data flow diagram illustrating transaction request processing in the communication number processing system.

FIG. 4 is a logic flow diagram illustrating the processing of a communication number to determine a risk score in the communication number processing system.

FIG. 5 is a logic flow diagram illustrating the processing of communication numbers to identify suspicious communication numbers in the communication number processing system.

FIG. 6 is a logic flow diagram illustrating information verification based on verification rules in the communication number processing system.

FIG. 7 is a logic flow diagram illustrating fraud analysis on communication numbers in the communication number processing system.

FIG. 8 is a logic flow diagram illustrating the processing of a communication number to allow or reject a transaction in the communication number processing system.

### DETAILED DESCRIPTION

A system and methods for processing a communication number for fraud prevention (“communication number processing system”) are described herein. The communication number processing system cleanses or scrubs communication numbers in order to ensure that they are usable for further processing and/or for initiating communication. The communication number processing system further determines attributes and/or characteristics of communication numbers. These attributes and/or characteristics range from standard attributes such as type of communication number or location to enhanced characteristics including behavioral, reputational, network-derived characteristics, and the like. The attributes and/or characteristics can be obtained from different sources such as network operators, device (e.g., a user's mobile phone), client feedback, and/or users (e.g., user behavior). The communication number processing system analyzes the attributes and/or characteristics using one or more rules to determine and quantify risks, authenticate, validate or verify communication numbers, provide reputational or fraud assessment, and the like. These determinations may be used during account creation, account verification, customer authentication, transaction verification or processing of any transaction requests to prevent or mitigate fraud. Further non-limiting examples of transaction requests include requests associated with financial transactions such as purchase transaction or banking transaction, other transactions such as changing an account setting or other details such as a communication number or an address, uploading or downloading resources, accessing sensitive information (e.g., bank account number, payment identifier, social security number), certain transactions that are deemed undesirable (generally or by a client) such as bulk account creation, spamming (e.g., sending messages with certain undesirable content or to a large number of recipients), or the like. As will be described in additional detail herein, an advantage of the disclosed communication number processing system is that the determinations may be made with minimal or no impact to the user experience.

In some embodiments, the communication number processing system also provides attributes and/or characteristics associated with communication numbers to client systems. The client systems may use their own risk models to process the information corresponding to the attributes and/or characteristics and assess risks. In other embodiments, the communication number processing system provides processed or derived communication number related data, such as suspicious communication numbers, communication number risk or fraud scores, and the like, to client systems. The client systems may then evaluate such risk scores and suspicious communication numbers in a manner that is desired or appropriate for their individual systems.

A communication number includes any identifier that can be used to place a voice call (e.g., a fixed telephone number), place a video call (e.g., a mobile phone number), send a short message service (SMS), send a multimedia message service (MMS), and/or initiate other types of communication. While this detailed description primarily describes the operation of the system with respect to communication numbers, it will be appreciated that the techniques disclosed herein for communication numbers are equally applicable to communication termination point identifiers. A communication termination point identifier need not be a numeric identifier, but can be any alphabetic or alphanumeric combination and may include special characters. Examples of communication termination point identifiers include an Internet handle (e.g., Skype handle MissJaneDoe, Twitter handle @MissJaneDoe), an email address, a phone number, and the like that can be used for communication.

Various implementations of the invention will now be described. The following description provides specific details for a thorough understanding and an enabling description of these implementations. One skilled in the art will understand, however, that the invention may be practiced without many of these details. Additionally, some well-known structures or functions may not be shown or described in detail, so as to avoid unnecessarily obscuring the relevant description of the various implementations. The terminology used in the description presented below is intended to be interpreted in its broadest reasonable manner, even though it is being used in conjunction with a detailed description of certain specific implementations of the invention.

### 1. SUITABLE ENVIRONMENTS

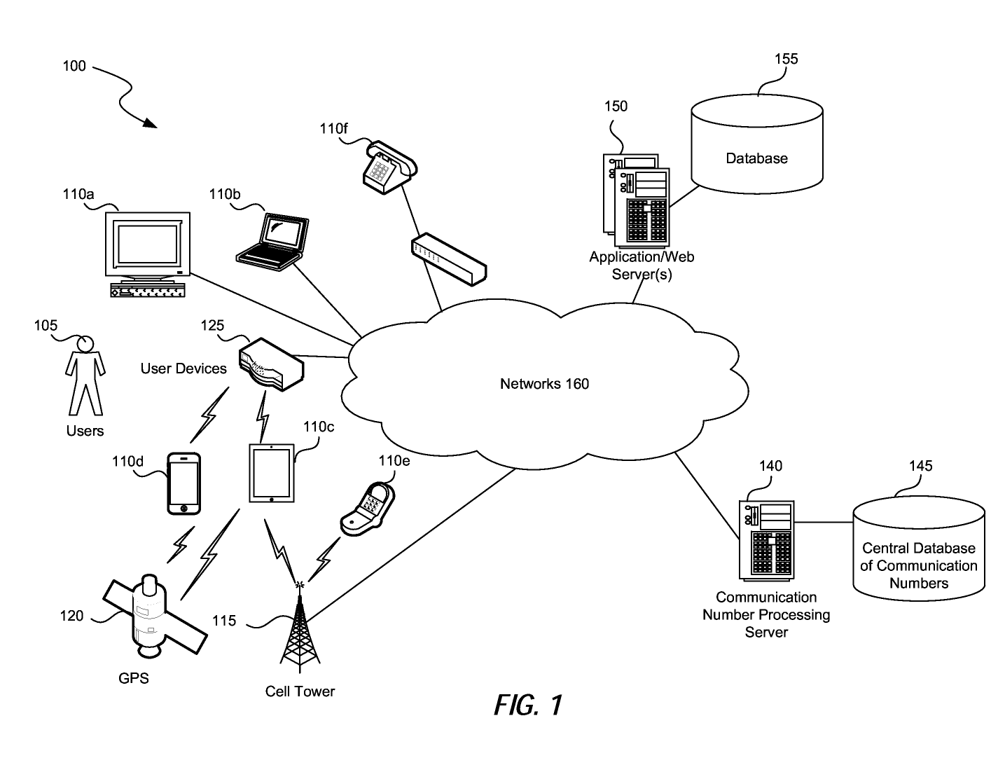

The communication number processing system may be implemented in a suitable computing environment 100, as shown in FIG. 1. Aspects, embodiments and implementations of the communication number processing system will be described in the general context of computer-executable instructions, such as routines executed by a general-purpose computer, a personal computer, a server, or other computing systems. The communication number processing system may also be embodied in a special-purpose computer or data processor that is specifically programmed, configured, or constructed to perform one or more of the computer-executable instructions explained in detail herein. Indeed, the terms “computer” and “computing device,” as used generally herein, refer to devices that have a processor and non-transitory memory, like any of the above devices, as well as any data processor or any device capable of communicating with a network. Data processors include programmable general-purpose or special-purpose microprocessors, programmable controllers, application-specific integrated circuits (ASICs), programmable logic devices (PLDs), or the like, or a combination of such devices. Computer-executable instructions may be stored in memory, such as random access memory (RAM), read-only memory (ROM), flash memory, or the like, or a combination of such components. Computer-executable instructions may also be stored in one or more storage devices, such as magnetic or optical-based disks, flash memory devices, or any other type of non-volatile storage medium or non-transitory medium for data. Computer-executable instructions may include one or more program modules, which include routines, programs, objects, components, data structures, and so on that perform particular tasks or implement particular abstract data types.

Embodiments of the communication number processing system may be implemented in distributed computing environments, where tasks or modules are performed by remote processing devices, which are linked through a communications network, such as a Local Area Network (“LAN”), Wide Area Network (“WAN”), or the Internet. In a distributed computing environment, program modules or subroutines may be located in both local and remote memory storage devices. Aspects of the communication number processing system described herein may be stored or distributed on tangible, non-transitory computer-readable media, including magnetic and optically readable and removable computer discs, stored in firmware in chips (e.g., EEPROM chips), an array of devices (e.g., Redundant Array of Independent Disks (RAID)), solid state memory devices (e.g., solid state drives (SSD), Universal Serial Bus (USB)), and/or the like. Alternatively, aspects of the communication number processing system may be distributed electronically over the Internet or over other networks (including wireless networks). Those skilled in the relevant art will recognize that portions of the communication number processing system may reside on one or more server computers, while corresponding portions reside on a client computer. Data structures and transmission of data particular to aspects of the communication number processing system are also encompassed within the scope of the invention.

FIG. 1 illustrates an exemplary environment 100 in which the communication number processing system embodied in a communication number processing server 140 or servers operates. The environment includes a plurality of client devices such as a desktop computer 110a, a laptop computer 110b, a tablet 110c, a mobile device 110d, a feature phone 110e, a fixed telephone 110f, and the like. At least some of the client devices may be used by users 105 to access websites and/or applications that are hosted or supported by application servers and/or web servers represented by an application server or web server 150 over a network 160. Communication numbers that are received, stored and/or processed by the communication number processing server 140 are associated with the client devices 110a-f. By way of an example, a communication number includes an E-164 number, which may be associated with a mobile phone (e.g., 110d, 110e) or a fixed telephone (e.g., 110f). By way of another example, a 11/26/13 communication number includes a virtual phone number provided by Google Voice, Skype, Vonage and other similar service providers.

The client devices 110a-110f, via network interfaces, connect to and/or communicate with networks 160, either directly, or via telephone routing hardware, wireless routers, or cell towers. Networks 160 may include wired and wireless, private networks and public networks (e.g., the Internet). Network interfaces employ connection protocols such as direct connect, Ethernet, wireless connection such as IEEE 802.11a-n/ac, and the like to connect to networks 160. Some client devices, such as device 110f, may be equipped with circuitry to handle POTS (plain old telephone service) or VoIP (Voice over Internet Protocol) connections. Some client devices such as devices 110c-110e may be equipped with transceiver circuitry to handle radio communications to wirelessly communicate with nearby cell towers or base stations using wireless mobile telephone standards, such as Global System for Mobile Communications (GSM), CDMA (Code Division Multiple Access), General Packet Radio Service (GPRS), and/or the like.

As illustrated in the exemplary environment 100, the communication number processing server 140 communicates with multiple application servers (e.g., application server 150) over the networks 160. The communication number processing server connects to or is otherwise coupled with a database 145 of communication numbers and related data. The communication number processing server 140 stores attributes, characteristics and/or other data relating to communication numbers in the database 145. In some embodiments, the information in the database is utilized by the communication number processing server to generate, maintain and/or apply verification rules in verifying communication numbers, determining risks (e.g., risk factors, risk scores), identifying suspicious communication numbers, providing reputational assessment, and the like.

The application/web server 150 is a server or a group of servers hosting one or more websites and delivering web pages to requesting clients. In some embodiments, the application/web server 150 may be a server or a group of servers providing data and supporting operations of applications (e.g., mobile or web applications) installed on or accessed from various client devices (e.g., client devices 110a-e). The application/web server 150 may be coupled to a database 155 that stores data relating to users or user accounts (e.g., user 105), and other data. In some embodiments, the application/web server 150 may also handle authentication and verification of users (e.g., users 105), verification of transactions, verification of client devices, and the like. The application/web server 150 communicates with the communication number processing server 140 to request attributes or other enhanced characteristics associated with communication numbers. The application/web server 150 further utilizes the obtained attributes or other enhanced characteristics associated with communication numbers for authentication, transaction verification, account creation/user registration, and the like.

### 2. SUITABLE SYSTEMS

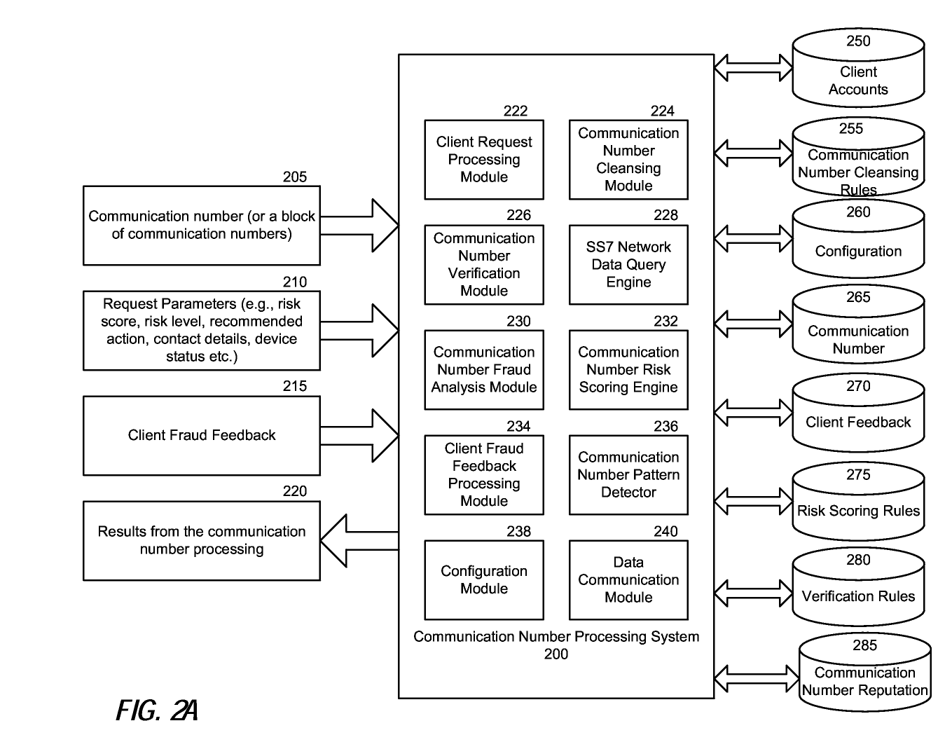

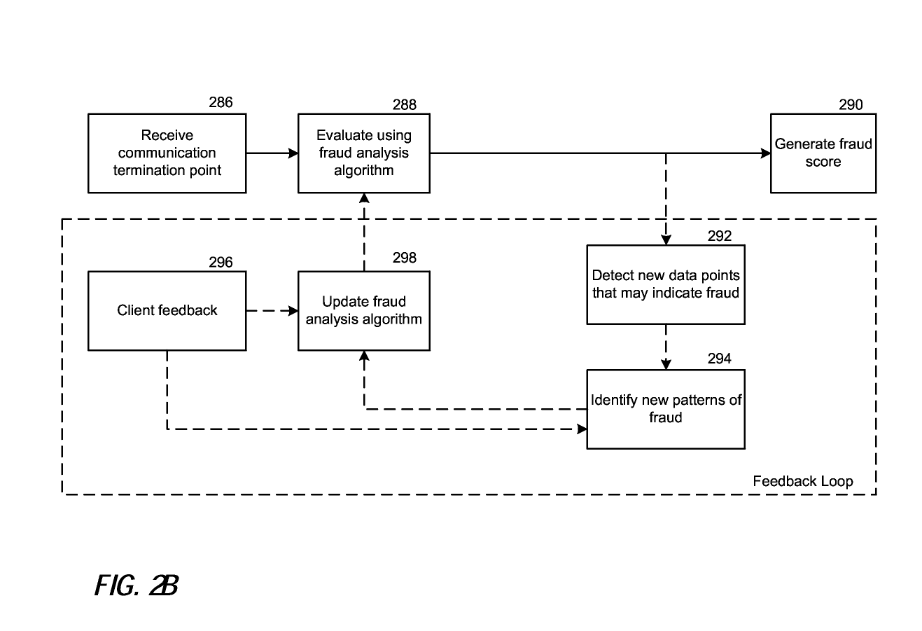

FIG. 2A is a block diagram illustrating an embodiment of a communication number processing system 200 and some of the data that is received, stored, processed and transmitted by the system. The communication number processing system receives a communication number or a block of communication numbers (e.g., a batch query or request), cleanses the communication numbers, determines associated attributes and/or characteristics of the communication numbers, and provides the associated attributes and/or characteristics as an output. The communication number processing system 200 further uses at least some of the attributes and/or characteristics (e.g., reputational characteristics) to perform a reputational assessment of a communication number and provide results of the reputational assessment as an output. In some embodiments, the communication number processing system uses at least some of the attributes and/or characteristics and/or results from the reputational assessment associated with a communication number to generate a fraud assessment. In the case of a batch query relating to multiple communication numbers, a consolidated response including fraud assessments relating to each of the multiple communication numbers can be generated and provided as an output.

Various inputs may be provided to the communication number processing system 200. For example, a communication number or a block of communication numbers 205 is provided, as a part of a request, to the communication number processing system 200. In some instances, one or more parameters 210 are included in the request for processing one or more communication numbers.

The inputs provided to the communication number processing system 200 are processed by one or more modules and/or engines. For example, a client request processing module 222 of the communication number processing system handles the request by parsing the request and extracting the communication numbers and any specified request parameters. The client request processing module 222 invokes other modules or engines to process the communication numbers and generate results that meet the specified request parameters. Various request parameters may be specified to request for specific pieces of information. For example, the parameters may specify a request for a risk score, a risk level, a risk code, a recommended action, an address associated with the communication number, a current or past location of the device associated with the communication number, or a current status, attributes, network-derived characteristics, reputational characteristics, and the like of the device associated with the communication number.

In some embodiments, the client request processing module 222 passes the communication numbers to a communication number cleansing module 224 for cleansing or scrubbing the communication numbers. The process of cleansing or scrubbing of communication number may include a systematic examination of the communication numbers using one or more rules to identify and remedy inconsistencies such as invalid communication numbers, formatting errors, duplicates, and the like to obtain communication numbers that are dialable and traceable. Communication numbers properly entered into a system are often undialable due to user interface problems, software incompatibilities, or user error. For instance, a communication number “+44 07 1234567” has a country code “44,” a city code “07,” and a phone number “1234567.” Even if the communication number is properly known by the user, due to a user interface or user error the country code is frequently duplicated before the communication number is dialed. Thus, instead of “+44 07 1234567,” an incorrect communication number such as “+44 44 07 1234567” can be received or dialed. The communication number cleansing module 224 identifies and eliminates the duplicate country code to maintain proper formatting. In addition, the communication number cleansing module 224 may also standardize dialing formats based on the location and destination of the communication numbers. Certain countries require different number formats depending on whether the calls are within the country or outside the country. Using the example discussed above, while communication number “+44 07 1234567” may be proper when used within the United Kingdom, it is not when it is dialed from outside the United Kingdom due to the unnecessary leading digit in the city code. The communication number cleansing module 224 can detect and amend the communication numbers to the proper format based on location. Moreover, the communication number cleansing module 224 may adapt to a country's phone number plan updates. For example, national and regional number systems (e.g., country codes, area codes) may be updated when an increase in population in a certain region creates a shortage of phone numbers. The communication number cleansing module 224 can update dialing plans by converting the older phone numbers to the new area numbering plan.

To cleanse or scrub the communication numbers, the communication number cleansing module 224 utilizes one or more cleansing rules (e.g., cleansing rules stored in the communication number cleansing rules database table 255) to, for example, correct typographical errors, to standardize formatting, update dialing plans, eliminate duplicate entries, detect incorrect communication numbers, and the like. In some embodiments, in order to cleanse a communication number, the communication number cleansing module 224 applies one or more rules in different orders and combinations and compares the cleansed number against known dialing plans. In other embodiments, the communication number cleansing module 224 may also incorporate and/or implement rules provided or specified by clients and/or other third-parties or rules that are self-learned using various machine-learning techniques. Where there are multiple matches, the communication number cleansing module 224 selects a version of the communication number that most closely matches a known dialing plan as a cleansed number. Where multiple complete matches are found, the communication number cleansing module 224 selects a version that most closely matches the uncleansed number as a cleansed number.

In an embodiment, the communication number cleansing rules database 255 includes various data fields such as, but not limited to: communication number localization rules, communication number dialing rules, communication number error processing rules, communication number standardization rules, omission processing rules, formatting mistake processing rules, typographical error processing rules, communication number dialing plan update rules (for example, updated area code information for the communication number), and the like.

In some embodiments, the client request processing module 222 provides the communication number (in the original or cleansed form) and/or the parameters of the request to a SS7 (Signaling System No. 7) network data query engine 228 to obtain network characteristics data relating to the communication number. SS7 is a global standard for telecommunications, defining a set of signaling procedures and protocols that are used by telecommunication operators around the world to communicate with each other. The SS7 protocols and procedures are used to route, control and set up wireless (i.e., mobile or cellular) and wireline calls. Mobile networks (e.g., 2G, 3G, 4G, and the like) use the SS7 for call and short message service (SMS) delivery, roaming, mobility management, prepaid, subscriber authentication, and various other services. The SS7 network data query engine 228 and systems and methods for determining characteristics of a communication number are described in detail in U.S. Provisional Patent Application Ser. No. 61/890,142 (Attorney Docket No. 82797-8007.US00), entitled “SYSTEM AND METHODS FOR PERFORMING AUTHENTICATION, FRAUD, OR RISK ASSESSMENT OF A MOBILE DEVICE USING NETWORK DATA,” filed Oct. 11, 2013, which is herein expressly incorporated by reference in its entirety. The data returned by the SS7 network data query engine 228 are stored in a communication number database table 265 in association with the communication number.

The communication number database table 265 may include various data fields such as, but not limited to: a communication number, a subscriber name, a subscription type, a communication number type, a communication number address, a communication number location, a communication number status, and the like. The communication number subscriber name includes, for example, a first name, a last name, a preferred name, a company name, and the like. The communication number subscription type may include a cellular subscription, a residential subscription, a business (or corporate) subscription, and the like. The communication number type includes information regarding a type of service attached to a communication number. For example, a communication number may indicate a mobile, landline, non-fixed VoIP, invalid, pre-paid, personal, virtual, pager, toll-free, restricted, payphone, voicemail, undetermined and/or other type of service, and the like. The communication number address includes addresses associated with a communication number. For example, a communication number may have address records associated with an address where the communication number was activated, the address where the communication number is registered or billed, and the like. The address may comprise a street number, a street name, a city, a county (or the like), a state (or the like), a country, a zip code (or the like), a latitude, a longitude, a time zone, and the like. The communication number location may include a current location of a device (if such a device exists) associated with a communication number. For example, location data may include the current geographic location of a communication number. The communication number status may include a current operational status of a communication number. Location information may also include a cell identification, location area code, location number, geographic location, age of the location information, indication if current location was retrieved (e.g., by paging procedure), tracking area identification, and the like. Example operational status data may include a subscriber status (active, disconnected, or the like), a device status (reachable, unreachable, or the like), a roaming status (roaming, not roaming, or the like), a roaming country, and the like.

When the client request processing module 222 uses the SS7 network data query engine 228 to retrieve information related to a communication number, the SS7 network queries are executed in real-time. Thus the information returned by the SS7 network data query engine 228 is generally up-to-date and accurate. In some embodiments, the client request processing module 222 directly queries the communication number database table 265 using the communication number (cleansed or otherwise) to retrieve the requested information. The decision regarding whether to invoke the SS7 network data query engine 228 or perform a direct query on the communication number database table 265 may be based on the request parameters and/or whether a record for the communication number in question is present in the communication number database table. For example, for a given communication number “310 555 5555” and a request parameter that specifies a device status, the client request processing module 222 may request the SS7 network data query engine 228 to retrieve information on the device status, regardless of whether or not a record for the given communication is in the database 265. The real-time query ensures that the device status information returned to a requestor is not stale.

In some embodiments, information retrieved from the database 265 and/or the SS7 network data query engine 228 is provided, without additional processing, as an output 220. For example, if the request parameters 210 specify contact details for a communication number, the communication number processing system uses the communication number (in cleansed or uncleansed form) to retrieve the requested information (directly from the SS7 network query and/or from database table 265) and provide the retrieved information as output 220. An example response formatted in XML and generated by the communication number processing system 200 in response to a request for details on a communication number is provided below:

<xml version=“1.0” encoding=“UTF-8”?>

<communication_number_details>

<communication_number>

<id>310 555 5555</id>
<subscriber_name>John Doe</subscriber_name>
<created_on>2002-01-10 2:01:05</created_on>
<location>

<subscriber_address>

<address>123 Main St. #31</address>
<city>Marina Del Rey</city>
<state>California</state>
<zip_code>90292</zip_code>
<country>USA</country>

</subscriber_address>
<current_location>

<coordinates>33.971973,−118.243488</coordinates>
<timestamp>20XX-01-01 4:01:10</timestamp>

</current_location>

</location>
<phone_type>Mobile</phone_type>
<phone_status>Idle</phone_status>

</communication_number>

</communication_number_details>

In some embodiments, the communication number processing system 200 receives a request to verify a communication number. A communication number verification module 226 verifies the communication number by retrieving and evaluating data associated with the communication number using one or more verification rules (e.g., from verification rules database table 280). The data associated with the communication number may include the data stored in the communication number database table 265, and other data including data stored in the communication number reputation database table 285. The communication number reputation database table 285 may include various data fields such as, but not limited to: a number of correct/incorrect responses during a verification attempt, a number of verification attempts, a length of time between verification attempts, a failed verification count, a successful verification count, a total verification count, transaction history, customer rating, report or profile, history of changes to communication number type, address, location, status, and the like, fraud level, date, time, reported fraudulent transaction history, other reported reputational data, and the like. In one embodiment, some of the information in the reputation database table 285 is sourced from client reporting and/or feedback.

In some embodiments, the communication number verification module 226 verifies the communication number by determining whether the communication number is valid and/or reachable. For example, the communication number verification module 226 determines, based on a query to the SS7 network (e.g., via the SS7 network data query engine 228), whether the communication number is idle, busy, invalid or not reachable, without having to initiate an SMS or a phone call to the communication number. In some embodiments, the communication number verification module 226 initiates an SMS, a phone call, an instant message, or the like to the communication number to initiate verification of the communication number. For example, the communication number verification module 226 determines whether the communication number is valid and reachable, and if so, initiates an SMS including a verification code (e.g., a PIN, a password, a pass code) or initiates a phone call and provides a verification code during the phone call. A user of a device associated with the communication number can then respond with a verification code, and if there is a match between the response code and the code provided, the communication number is deemed verified. The communication number verification module 226 may maintain a transaction log that details date/time, communication numbers and types of actions taken.

In another embodiment, the communication number verification module 226 verifies the communication number by comparing communication number related data obtained from one source with similar data obtained from another source. For example, the communication number verification module 226 receives user provided information (e.g., name, address, communication number) and compares the user provided information with retrieved communication number related data (e.g., from SS7 network data query engine 228 and/or the communication number database table 265) to determine whether the information from the two sources match. If there is a match, the communication number is deemed verified. In some embodiments, instead of or in addition to the functions described above, the communication number verification module 226 performs the functions described in reference to a communication number fraud analysis module 230 to verify a communication number in accordance with one or more verification rules.

In some embodiments, a communication number fraud analysis module 230 analyzes attributes and/or characteristics, including behavioral, reputational, location and other characteristics associated with the communication number to determine whether the communication number is suspicious or potentially fraudulent. A suspicious communication number can be flagged as such, and provided as an output 220. Identification of a suspicious communication number allows a client (e.g., a website, application/web server 150 of FIG. 1) to take necessary steps to mitigate risks. For example, when the client system has knowledge that a user is associated with or has provided a suspicious communication number, the client system can utilize its own rule engine to determine whether to suspend a transaction with the user, include an additional factor of authentication to authenticate the user, initiate a text, instant message (IM) or call to the suspicious communication number, or take other steps to avoid fraud. Various authentication methods, including those disclosed in related U.S. patent application Ser. No. 13/706,261 entitled “FRICTIONLESS MULTI-FACTOR AUTHENTICATION SYSTEM AND METHOD” (Attorney Docket No. 827927-8005.US00) filed on Dec. 5, 2012 and U.S. patent application Ser. No. 13/844,417 entitled “SYSTEM AND METHOD FOR UTILIZING BEHAVIORAL CHARACTERISTICS IN AUTHENTICATION AND FRAUD PREVENTION” (Attorney Docket No. 82797-8006.US00) filed on Mar. 15, 2013, may be used.

The communication number fraud analysis module 230 analyzes fraud in a number of ways. In some embodiments, the communication number fraud analysis module 230 is based on one or more models that examine attributes and/or characteristics, including device, location, behavioral, reputational, network-derived characteristics, and the like to identify presence of one or more indicia of fraud. The communication number processing system establishes, identifies and/or configures a set of indicia of fraud based on historical data associated with fraud, data (e.g., instances of fraud, one or more indicia of fraud) reported by a user or client system interacting with the communication number processing system (e.g., via the client feedback processing module 234), or a combination thereof. In an embodiment, the communication number processing system maintains a set of indicia of fraud. The communication number processing system may aggregate feedback or reporting from one or more clients or other sources to update (e.g., add, delete, rank by priority, importance or effectiveness in detecting fraud) the set of indicia of fraud. For example, the set of indicia of fraud shown in Table 1 below may be updated based on client reporting and/or based on new patterns of fraud (e.g., via the pattern detector 236). In another embodiment, the communication number processing system maintains a set of indicia of fraud specific to clients, groups of clients (e.g., clients grouped by business size, industry, premium account), transaction types (e.g., account creation, financial transaction such as purchase transaction or banking transaction, authentication, other transactions such as changing an account setting or other details, uploading or downloading resources, or the like). An indicia of fraud may be associated with a communication number type, a communication number address, a communication number location, a communication number status, a reputational characteristic, a behavioral characteristic, and the like. Table 1 below provides an exemplary list of indicia of fraud (not arranged in any order) that the communication number fraud analysis module 230 may use to determine whether a communication number is suspicious (or potentially fraudulent) or not. Table 1 is illustrative only, and additional indicia of fraud may be used in detecting fraud.

TABLE 1
Exemplary Indicia of Fraud Associated
With a Communication Number

| | Indicia of Fraud |
|---|---|
| 1 | Communication number type (e.g., undetermined, prepaid, mobile, |
| | toll free, non-fixed VoIP, pager, pay phone, invalid, restricted |
| | number, virtual number, voicemail, portable, other) |
| 2 | Communication number address and current location mismatch |
| 3 | Communication number status (e.g., disconnected, unreachable, busy) |
| 4 | Roaming status (e.g., roaming in another country) |
| 5 | Service length (e.g., less than three months) |
| 6 | History of bill payment (e.g., number of instances of untimely bill |
| | payment) |
| 7 | Bill payment method (e.g., payment using a prepaid card or a number |
| | of different credit cards) |
| 8 | History of verification (e.g., a number of incorrect verification |
| | responses, count of failed verifications) |
| 9 | History of reported fraudulent transactions |
| 10 | History of changes to communication number address and/or location |
| | (e.g., frequent change of billing address, geographically scattered |
| | location pattern) |
| 11 | Customer rating (e.g., negative customer rating) |

The exemplary list of indicia of fraud shown in Table 1 above includes certain communication number attributes and/or characteristics that are associated with higher risk, and are thus better predictors or indicators of fraud than others communication number attributes and/or characteristics having lower risk. By way of example, certain indicia such as a prepaid phone number, mismatched phone location and registration location, communication number status, roaming status, recent activation, history of untimely or irregular bill payment, among others, may suggest fraud in certain circumstances. For example, an online phone number or a prepaid phone number may be considered riskier than a mobile phone number, since it is relatively easy for anyone to setup an online phone account and obtain a phone number. Similarly, a prepaid phone can be purchased and disposed easily, and thus a prepaid phone number is risky. Similarly, when a communication number address such as the address where a communication number is registered does not match the current location of the communication number or the distance between the two locations appears anomalous, then the communication number is more likely to be associated with fraud. Certain network-derived characteristics such as a communication number status and a roaming status can also be considered as indicia of fraud. For example, when a communication number is disconnected, unreachable or busy, or remains so even after multiple retries, the communication number is likely to be associated with fraud, especially if it was recently connected. Similarly, a communication number that was recently activated may pose more risk than a communication number that has been activated for a longer time. Behavioral data such as history of untimely or irregular bill payment, use of certain bill payment methods and/or history of frequent changes to communication number details, as well as other historical data including feedback data relating to history of failed verifications or history of fraudulent transactions can also be considered as indicia of fraud. In some instances, negative customer ratings or other negative reviews, as well as client reporting, may also be considered as indicia of fraud.

One or more rules (e.g., pre-defined or learned rules) may be utilized in evaluating any indicia of fraud identified from an examination or analysis of communication number related data to determine whether the communication number is associated with fraud. As an illustrative example, the communication number fraud analysis module 230 determines that the communication number has a roaming status and is associated with a service length of less than three months. Based on the presence of these two particular indicia of fraud, the communication number fraud analysis module 230 flags the communication number as suspicious. In an embodiment, the fraud analysis module 230 also provides a recommendation on how to proceed with a transaction associated with the communication number. By way of another example, the communication number fraud analysis module 230 flags the communication number as suspicious when an examination of a communication number related data results in the presence of a number of indicia of fraud. Table 2 below provides example results and recommendations from a fraud analysis of a list of communication numbers.

TABLE 2
Results and Recommendations of a Fraud Analysis

| | Number of | | |
|---|---|---|---|
| | Indicia of | Fraud | |
| Communication | Fraud | Analysis | Recommended |
| Number | Identified | Result | Action |
| +13103330001 | 4 | Very suspicious | Suspend transaction |
| +13103330002 | 1 | Suspicious | Automated verification |
| +13103330004 | 2 | Suspicious | Automated verification |
| | | | after waiting period |
| +13103330006 | 0 | Not suspicious | Proceed with |
| | | | transaction |

As illustrated in Table 2, the communication number fraud analysis module 230 determines that the communication number “+13103330001” is associated with four indicia of fraud. The communication number fraud analysis module 230 then generates a very suspicious fraud assessment of the communication number based on the number of indicia of fraud identified (e.g., the indicia of fraud listed in Table 1) and a rule. The communication number fraud analysis module 230 then determines a recommended action for the very suspicious fraud assessment (e.g., using another rule that establishes a correspondence between a fraud assessment and a recommended action). In an embodiment, in addition to or instead of a total number of indicia of fraud identified or present in a set of data associated with a communication number, the communication number fraud analysis module 230 inspects the set of data associated with a communication number for presence of a specific indicium of fraud or a combination of specific indicia of fraud to generate a fraud assessment and/or recommended action for avoiding or mitigating the risk associated with the communication number.

The communication number risk scoring engine 232 determines a risk score or a fraud score for the communication number 205. In an embodiment, a calculation of a risk score for a communication number is based on a risk model that takes into consideration various factors indicative of fraud. Such factors may include, but are not limited to: static or standard or device attributes (e.g., type of communication number, carrier or provider) and enhanced factors such as location, behavior, historical, reputational, client feedback and reporting and network derived characteristics. Communication number related data associated with these factors may be obtained by initiating one or more queries to the SS7 network via the SS7 network data query engine 228 and/or from one or more database tables such as the communication number database table 265, the communication number reputation database table 285, a client feedback database table 270, and the like.

In an embodiment, a communication number risk score is calculated as a weighted sum or average of individual risk scores. The score generated may also be normalized to get a risk score within a certain range. By way of an example, a risk model for determining a risk score for a communication number may include: (1) static or standard; (2) location; (3) behavioral; (4) reputational; and/or (5) network-derived risk factors. By way of example, each risk factor may be assigned a weighting, as illustrated in Table 3 below.

TABLE 3
Risk Factors For Determining a
Communication Number Risk Score

| Risk Factors | Weighting | Maximum Score |
|---|---|---|
| Static or standard | 15% | 15 |
| Location | 15% | 15 |
| Behavioral | 15% | 15 |
| Reputational | 25% | 25 |
| Network derived | 30% | 30 |
| Total | 100% | 100 |

The communication number risk scoring engine 232 evaluates one or more attributes and/or characteristics associated with each risk factor according to one or more risk models in determining a communication number risk score. For example, for the static or standard risk factor, the risk scoring engine 232 determines whether a communication number is associated with a risky communication number type (e.g., mobile, non-fixed VoIP, invalid, pre-paid, personal, virtual, pager, toll-free, restricted, payphone, voicemail, undetermined) and/or a risky subscription type (e.g., a cellular subscription), and the like. The risk scoring engine 232 further evaluates the location risk factor by determining whether the communication number is associated with a risky location (e.g., current location that does not match the billing address or an Internet Protocol (IP) address associated with a transaction), current location is outside the country where the communication number is registered, current location is associated with fraudulent activity). Similarly, the behavioral risk factor may be evaluated by determining whether the communication number is associated with untimely, irregular or nonpayment of bills, bill payment using risky forms of payment, frequent changes to communication number address and/or location, and the like. Similarly, the reputational risk factor may be evaluated to determine whether the communication number is associated with verification failures, incorrect responses during verification attempts, reports of fraudulent transaction, negative customer rating, irregular or suspicious pattern of transactions and the like. Further, the network-derived risk factor may also be evaluated to determine whether a communication number is risky based on the roaming status, roaming country, operational status, device status, and/or other information obtained from one or more queries to the SS7 network (e.g., via the SS7 network data query engine 228).

In an embodiment, the scores associated with each risk factor are added together in accordance with the corresponding weights to determine a risk score for a communication number. In the example illustrated in Table 3, a higher risk score is indicative of higher risk or likelihood of fraud, while a lower score is indicative of lower risk or likelihood of fraud. It should be noted that the risk factors, weightings and maximum scores illustrated in Table 3 are exemplary. Various other risk factors including more or less number of risk factors, weightings and maximum scores may be considered in determining a risk score associated with a communication number in other embodiments. Further, other methodologies for determining a risk score for a communication number based on communication number related data are contemplated and are within the scope of the present disclosure. For example, in an embodiment, the risk scoring engine 232 identifies one or more indicia of fraud (e.g., from Table 2) from an analysis of data related to a communication number, and assigns a value to each identified indicia of fraud. In some instances, each indicia of fraud may be assigned a weighting. The values for the associated indicia of fraud are added together and normalized to get a risk score for the communication number.

In an embodiment, in addition to or in lieu of a risk score for a communication number, a rating is generated by the communication number risk scoring engine 232 to indicate a level of risk associated with a risk score or a range of risk scores. Table 4 below provides an example list of risk ratings and corresponding risk score ranges:

TABLE 4
Risk Scores and Ratings

| Risk Score Range | Risk Level | Recommendation |
|---|---|---|
| 801-1000 | High | Block |
| 601-800 | Medium-High | Block |
| 401-600 | Medium | Flag |
| 201-400 | Medium-Low | Allow |
| 0-200 | Low | Allow |

In an embodiment, the risk scoring engine 232 may be implemented as a configurable module to be tailored to the unique risks of different type of clients. The risk scoring rules (e.g., from risk scoring rules database table 275) for identifying risk factors and attributes, assigning weightings, and/or determining a score are selected or specified by clients. Clients may select certain risk scoring rules, while ignoring others and focus on specific risk factors and attributes. Additionally, the risk scoring engine 232 provides a plurality of different weightings that are optimized for different types of clients. Furthermore, the ratings corresponding to risk scores may also be customized by clients utilizing the communication number processing system 200.

In an embodiment, the client fraud feedback processing module 234 receives and processes client fraud feedback 215 provided by clients utilizing the communication number processing system 200. The feedback may include, for example, communication numbers that are associated with fraud, details relating to verification steps undertaken, indicia of fraud to be considered in analyzing communication numbers for fraud, and the like. The client feedback information may be stored in the client feedback table 270. The feedback confirms or verifies whether or not communication numbers identified as or predicted to be suspicious or potentially fraudulent or risky are in fact fraudulent. In some embodiments, information received as feedback is processed and/or analyzed by the client fraud feedback processing module 234 to determine and/or track accuracy of fraud detection, identify additional risk factors, adapt or tweak fraud analysis models (e.g., implemented by the communication number fraud analysis module 230), risk scoring models (e.g., implemented by the communication number risk scoring engine 232), and/or other modules.

For example, in an embodiment, the communication number processing system 200 identifies a communication number provided by a client as a suspicious communication number. Based on the assessment, the client (or the communication number processing system 200) initiates an additional verification step. If the verification step fails, or there is a long delay to complete the verification step, the client may decline the transaction associated with the suspicious communication number (or the communication number processing system 200 may recommend the client to decline the transaction). The client then provides an indication of verification failure to the communication number processing system 200 as a feedback. The communication number processing system receives the indication of verification failure (e.g., number of verification attempts, delay in providing a verification response, verification failure, verification method, and the like) and flags the suspicious communication number as a fraudulent communication number (e.g., in the communication number database table 265). In an embodiment, when the verification steps are performed by the communication number processing system 200, the results of the verification steps are tracked by the system 200 to confirm or verify that certain suspicious communication numbers are in fact fraudulent.

In an embodiment, the communication number pattern detector 236 detects patterns associated with clean (e.g., non-fraudulent or verified communication numbers) and/or suspicious or fraudulent communication numbers. The pattern detector 236 mines communication number related data, feedback from clients, post transaction data, and the like, to detect hidden patterns of fraud. Results from a pattern analysis (e.g., based on a cluster analysis or other pattern recognition techniques) are used by the communication number processing system 200 to improve on existing models for fraud analysis (e.g. implemented by the communication number fraud analysis module 230) and/or risk scoring (e.g., implemented by the communication number risk scoring engine 232), The pattern detector 236 can, for example, identify attributes and/or characteristics of communication numbers that are better predictors of fraud. By way of example, the pattern detector 236 can detect a pattern where communication numbers associated with a specific mobile carrier that were activated within a certain period of time (e.g., last three months) have a high level of failed verifications. The detected pattern (i.e., mobile carrier and date of activation) is then used to improve models implemented by modules such as the communication number fraud analysis module 230 and/or the communication number risk scoring engine 232, allowing such components to identify communication numbers with matching patterns and flag them as suspicious.

In an embodiment, some of the modules such as the communication number fraud analysis module 230 and/or the communication number risk scoring engine 232 are based on models (e.g., fraud analysis models, risk models) that are generated and/or refined by one or more machine-learning algorithms or techniques. In an embodiment, the algorithms implemented by the communication number processing system are based on supervised learning and use data relating to communication numbers that have been confirmed as fraudulent communication numbers (i.e., known data and known responses) to build and/or refine the models for predicting frauds and generating fraud risk scores. For example, a set of communication numbers validated as fraudulent numbers based on client feedback reporting, along with attributes and/or characteristics of the set of communication numbers, can be used to generate and/or refine a model for predicting or detecting fraud. Alternately, or in addition to the supervised learning, the system may implement algorithms based on unsupervised learning techniques to find hidden patterns of fraud in communication number attributes and/or characteristics to extract attributes and/or characteristics that are significant predictors of fraud. For example, based on an analysis of data relating to a set of communication numbers, a “length of service” attribute may be identified as a pattern. This pattern can be validated and used to create new rules to identify and reduce fraud risk. Based on the learned relationship between communication number attributes and/or characteristics and fraud or risk, the algorithms can refine the models, with little or no human intervention, to improve accuracy of fraud detection. Refining the models may include generating new rules, updating or deleting existing rules such as the risk scoring rules stored in the risk scoring rules database table 275 and/or the verification rules stored in the verification rules database table 280. Refining the models may further include adjusting weightings of certain risk factors, adding or deleting indicia of fraud to be considered in determining fraud, or the like.

In an embodiment, the configuration module 238 tracks client configurations for processing communication numbers, including risk scoring rules, verification rules, preferences, and/or other settings. The client configurations are stored in a configuration database table 260. Client information or client account information such as client identification, client name, address, service plan to use the services of the communication number processing system 200 (e.g., subscription plan, pay per query, pay per communication number), payment account information, and the like may be stored in the client accounts table 250. The data communication module 240 facilitates communication with client devices, servers and/or systems, operator networks, and the like that communicate with the communication number processing system 200.

It will be appreciated that the components 222-240 in FIG. 2A are representative of the various functions implemented by the system. Additional components such as a billing module for determining charges associated with communication number processing requests from clients, managing subscription, and the like may be included in the communication number processing system 200. Functions of some of the components may be consolidated into a single component or distributed among multiple different components in various embodiments of the communication number processing system.

### 3. EXAMPLE PROCESSING

A feedback driven process of evaluating fraud for generating a fraud score is illustrated in FIG. 2B. In an embodiment, the process starts when an identifier for a communication termination point (e.g., a communication number) is received at block 286. The identifier is evaluated by the communication number processing system using a fraud analysis algorithm implemented by the communication number fraud analysis module 230 and/or the communication number risk scoring engine 232 to generate a fraud score at block 290. The communication number processing system uses a feedback loop to tune the fraud analysis algorithm and/or rules for analyzing communication termination point identifiers to generate fraud scores for improved accuracy in detecting fraud. In an embodiment, feedback loop uses an algorithm (e.g., implemented by the fraud analysis module 230) to detect new data points indicative of fraud at block 292. The new data points indicative of fraud may be detected from examination or analysis of standard, location, behavioral, reputational, network derived and/or historical data relating to a communication termination point identifier or a subset of communication termination point identifiers. At block 294, the algorithm identifies new patterns of fraud using, for example, the communication number pattern detector 236. Further, client feedback 296 regarding accuracy of fraud detection, transaction verification details, and the like may also be used to detect new data points indicative of fraud and/or identify new patterns of fraud. The new patterns of fraud may be used to update the fraud analysis algorithm at block 298. For example, new indicia of fraud may be included while other indicia of fraud that are not relevant may be excluded in detecting fraud or generating the fraud score. By way of another example, the weightings of certain indicia of fraud or risk factors can be adjusted. Similarly, risk scoring rules (e.g., the rules stored in the risk scoring rules database table 275) utilized by the fraud analysis algorithm can be updated. In some instances, client feedback relating to specific indicia of fraud, rules, weightings for fraud score generation, and the like can also cause an update of the fraud analysis algorithm. In some embodiments, feedback loop driven tuning of the fraud analysis algorithm occurs dynamically as new data points and/or new patterns of fraud are identified. In other embodiments, when an update to the fraud analysis algorithm meets certain criteria such as a deletion update or generates a conflict with client instructions or requirements, then the algorithm may prompt for confirmation from an administrator or other user of the communication number processing system. Alternatively, in some embodiments, all updates to the fraud analysis algorithm may require prior authorization or approval.

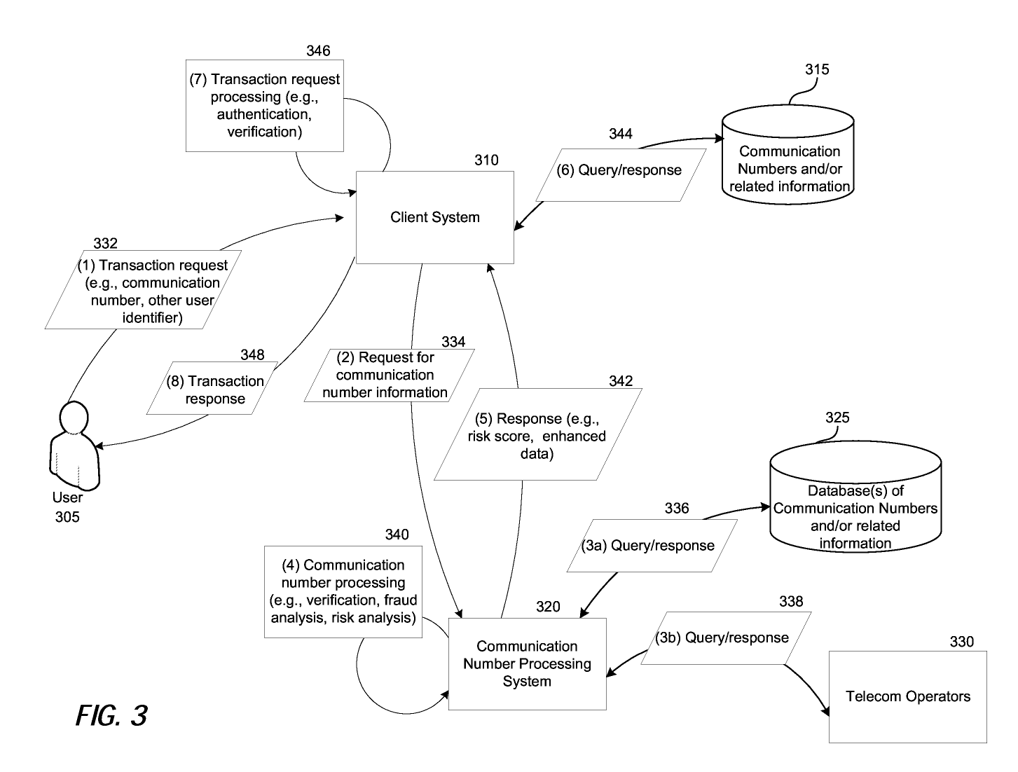

An example interaction between a user 305, a client system 310, a communication number processing system 320 and telecommunication operators 330 is illustrated in a data flow diagram of FIG. 3. The client system 310 is any system including a website, an application, a computer, a device, a program or a combination thereof that is capable of communicating with the communication number processing system 320 to request information relating to communication numbers, and obtain and process responses from the communication number processing system 320 to make decisions regarding a transaction such as an authentication transaction, a verification transaction, and the like. The communication number processing system 320 includes various components such as those described in FIG. 2A for processing and responding to requests from client systems, such as the client system 310, across a network.

As illustrated, a user 305 submits a transaction request 332 to the client system 310. The transaction request may be to sign up for an online account, register to a website service, or any other type of request requiring an assessment of risk associated with the transaction request based on a communication number associated with the user or the transaction request. The transaction request 332 may be made via a website or an application. The transaction request 332 may include a communication number and/or other user identifying details such as name, user identifier, email address, password, or the like. The contents of the transaction request 332 typically will depend on the type of transaction being requested. For example, an authentication request may include user credentials, while a request to change an account setting may include data relating to the change. An example transaction request substantially in the form of a HTTP(S) POST message including XML-formatted data is provided below:

POST /authrequest.php HTTP/1.1
Host: www.abc.com
Content-Type: Application/XML
Content-Length: 667
<?XML version = ”1.0” encoding = ”UTF-8”?>
<auth_request>

<timestamp>20XX-02-22 15:22:00</timestamp>

<user_details>

<user_name>JDoe@gmail.com</account_name>
<password>password123</password>
<comm_number>503-552-5567</comm_number>

</user_details>
<client_details>

<client_IP>192.168.13.133</client_IP>
<client_type>smartphone</client_type>
<client_model>Samsung galaxy SII</client_model>
<OS>Android 4.0</OS>
</client_detail>

</auth_request>

The client system 310 receives the transaction request 332 and parses the transaction request to extract parameters of the request. The client system 310 then sends a request 334 for information relating to the communication number to the communication number processing system 320. In an embodiment, the client system 310 makes an API call or uses another method call to communicate with the communication number processing system 320 to retrieve communication number related information. An example API call for retrieving information (e.g., Phone ID Score or communication number risk score) relating to a communication number (e.g., 310-333-0001) is provided below:

http://server1.xyz.com/verification/api/getPhoneIDScore?callid=1100
10&callno=20&apikey=fk8Le765gh6fg_ghr67j&token=u:765fghl87h876gh98j
h676fg4r5r7u99&phone=3103330001&clientid=5767899080

The communication number processing system 320 receives and processes the request 334 to return the requested information (i.e., a Phone ID Score). The communication number processing system 320 queries a database of communication numbers and/or other related information 325 to retrieve information 336. The communication number processing system 320 may also query telecom operators 330 to retrieve information 338 associated with the communication number. The communication number processing system 320 then processes the retrieved information at block 340 (e.g., response 336/338) to obtain the requested information. For example, when a Phone ID Score is requested, the communication number processing system 320 determines a risk score for the communication number (e.g., via the communication number risk scoring engine 232). The communication number processing system 320 then provides a response 342 to the client system 310. An example response including XML-formatted data is provided below:

<xml version=“1.0” encoding=“UTF-8”?>

<phoneid_score>

<timestamp>20XX-02-22 15:22:43</timestamp>
<client_ID>5767899080</client_ID>

<phoneid_score_details>

<id>310 333 0001</id>
<subscriber_name>John Doe</subscriber_name>
<phone_type>Mobile</phone_type>
<score>22</score>

</phoneid_score_details>

</phoneid_score>

The client system 310 receives the response 342. In an embodiment, the client system 310 further queries its own database of communication numbers and/or related information 315 to retrieve additional information 344 and/or store the response 342 in the database 315. The client system 310 may also query another database or database table to obtain rules for evaluating the transaction request and the response 342. The client system 310 then processes the transaction request 332 at block 346 using information provided by the communication number processing system 320, information retrieved from its own databases including one or more rules for evaluating the information to determine whether to allow or deny the transaction request. For example, for a Phone ID score between 0 to 400, the client system may determine that the level of risk is acceptable and decide to grant the transaction request. Alternately, for a Phone ID score between 601 to 1000, the client system 310 may determine that the transaction is risky, and deny the transaction request. By way of another example, the client system 310 requests and receives a response similar to the XML-formatted response provided in reference to FIG. 2A from the communication number processing system 320. The client system 310 utilizes the received information and optionally supplements the received information with its own data to make a fraud or risk assessment of the communication number and determine, based on such assessment, whether to approve or reject the transaction request 332. The client system 310 can also reassess the transaction request 332 in the form of a challenge if additional steps for authentication are required. The result of the transaction request processing 346 is then provided to the user 305 as a transaction response 348.

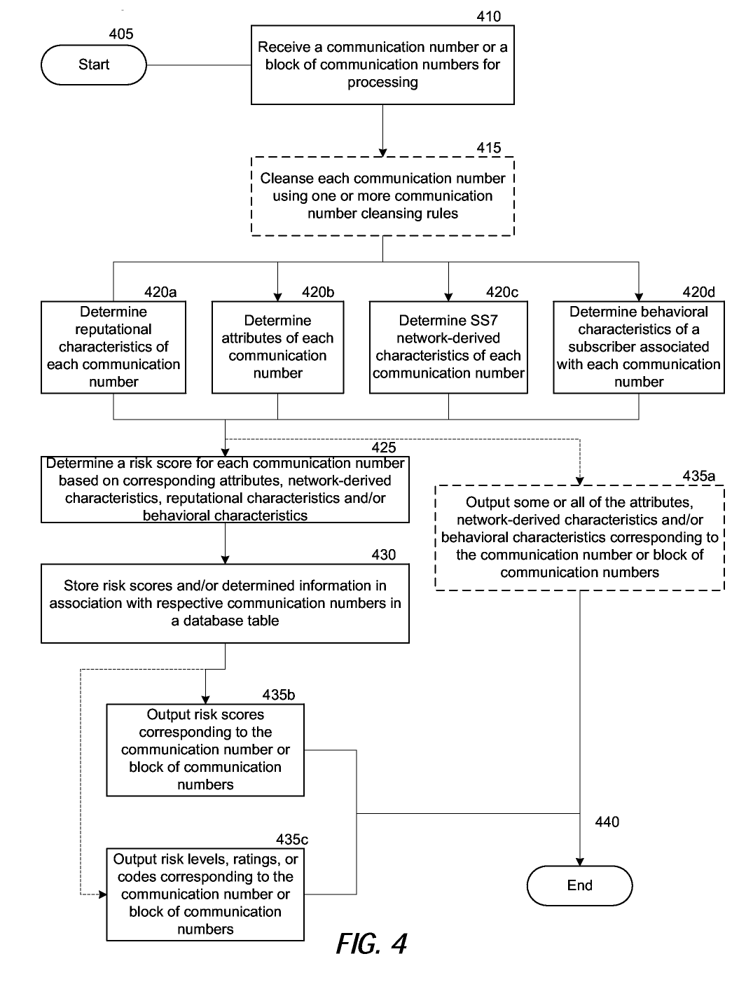

An example method for processing of a communication number to determine characteristics of the communication number is illustrated in FIG. 4. The method starts at block 405. A communication number processing system receives a communication number or a block of communication numbers for processing at block 410. The communication numbers may be in different or non-standard formats and may need to be cleansed or scrubbed to remove any errors, inconsistencies, and the like. At block 415, the communication number processing system (e.g., via the communication number cleansing module 224 in FIG. 2A) cleanses each communication number or at least those communication numbers that need cleansing using one or more communication number cleansing rules. In some implementations, block 415 may be an optional step.

At block 420a, the communication number processing system determines reputational characteristics of each communication number. In an embodiment, the determination includes retrieving reputational characteristics data from a database table (e.g., communication number reputation database table 285). The reputational characteristics may also be determined from at least some or all of the client feedback information (e.g., from client feedback 215, client feedback table 270). The reputational characteristics of a communication number may be tracked over time and may be supplemented by information provided by client systems. At block 420b, the communication number processing system determines attributes of each communication number. The attributes may include standard attributes such as, but not limited to: a communication number type, communication number activation address, communication number registration address, a communication number location, subscriber name, subscriber address, carrier/server provider information, subscription type, and the like. At block 420c, the communication number processing system determines SS7 network-derived characteristics of each communication number. The SS7 network-derived characteristics may be obtained via real time queries (e.g., using the SS7 network data query engine 228) and may include, for example, a current operational status of a communication number including a subscriber status (active, disconnected, or the like), a device status (reachable, unreachable, or the like), a roaming status (roaming, not roaming, or the like), a roaming country, and the like. At block 420d, the communication number processing system determines behavioral characteristics of a subscriber associated with each communication number. The behavioral characteristics may include, for example, information relating to bill payment history, bill payment methods, history of changes to communication number or other user information, whether the phone number has been verified multiple times, and the like. Depending on the implementation, the communication number processing system may implement one or more of the blocks 420a-d.

In an embodiment, the communication number processing system determines a risk score for each communication number based on corresponding reputational characteristics (from block 420a), attributes (from block 420b), network-derived characteristics (from block 420c) and/or behavioral characteristics (from block 420d) at block 425 (e.g., via the communication number risk scoring engine 232). At block 430, the communication number processing system stores the risk scores and/or determined information (from blocks 420a-d) in association with respective communication numbers in one or more database tables. The communication number processing system outputs a risk score or multiple risk scores corresponding to the communication number or the block of communication numbers at block 435b. In another embodiment, instead of risk scores, the communication number processing system outputs risk levels, ratings or codes corresponding to the risk scores for the communication numbers at block 435c. In yet another embodiment, at block 435a, the communication number processing system outputs some or all of the reputational characteristics, attributes, network-derived characteristics and/or behavioral characteristics corresponding to the communication number or the block of communication numbers for further processing by the receiving system. The method concludes at block 440.

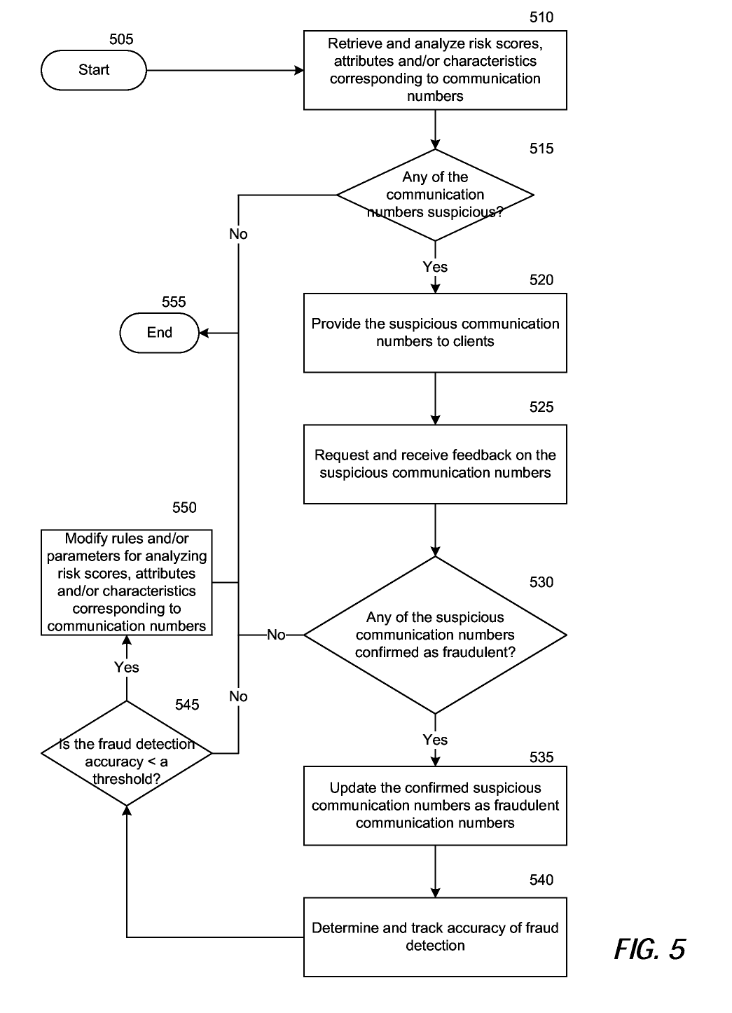

An example method for processing of communication numbers to identify suspicious communication numbers is illustrated in FIG. 5. The method starts at block 505. A communication number processing system retrieves and analyzes communication number related information such as risk scores, attributes and/or characteristics associated with multiple communication numbers (or one communication number) at block 510. In an embodiment, the communication numbers are provided by a client system for identification of suspicious communication numbers. In another embodiment, the communication numbers belong to a list that is periodically analyzed for fraud identification (e.g., a watch list). The analyzing at block 510 involves identification or detection of one or more indicia of fraud, such as those listed in Table 1 above, and/or use of one or more rules to, for example, determine whether a communication number is suspicious. In an embodiment, the analyzing of the retrieved information to identify one or more indicia of fraud may be performed by the communication number fraud analysis module 230, the communication number risk scoring engine 232, or both. At decision block 515, if the communication number processing system determines that none of the communication numbers are suspicious based on the analyzing at block 510, the communication number processing system generates a notification or response indicating the result and the method ends at block 555.

Alternately, if one or more suspicious communication numbers are detected, the communication number processing system feeds the suspicious communication numbers to a client system at block 520. The communication number processing system may also update its database tables to flag the suspicious communication numbers. At block 525, the communication number processing system requests and receives feedback on the suspicious communication numbers. The feedback may be obtained from the client system or from a component of the communication number processing system, such as the communication number verification module 226. At decision block 530, if no confirmed suspicious numbers have been reported, the method concludes at block 555. However, based on the examination or processing of the feedback (e.g., via the client fraud feedback processing module 234), if at least some of the suspicious communication numbers are confirmed as fraudulent, the communication number processing system updates the pertinent database tables to mark the confirmed suspicious communication numbers as fraudulent communication numbers at block 535.

At block 540, the communication number processing system determines and/or updates the accuracy of fraud detection. The accuracy of fraud detection are tracked over time to assess the effectiveness of existing rules, algorithms and/or risk models for risk score calculation, fraud analysis, and the like. At decision block 545, the communication number processing system determines if the fraud detection accuracy is less than a threshold. If so, the communication number processing system modifies rules, algorithms and/or risk models for risk score calculation, fraud analysis and the like for analyzing attributes and/or characteristics corresponding to communication numbers at block 550. For example, the communication number processing system can utilize the communication number pattern detector 236 to detect new patterns of fraud. If the fraud detection accuracy is acceptable, the method concludes at block 555, without making any modification to the rules, algorithms and/or risk models for risk score calculation, fraud analysis and the like.

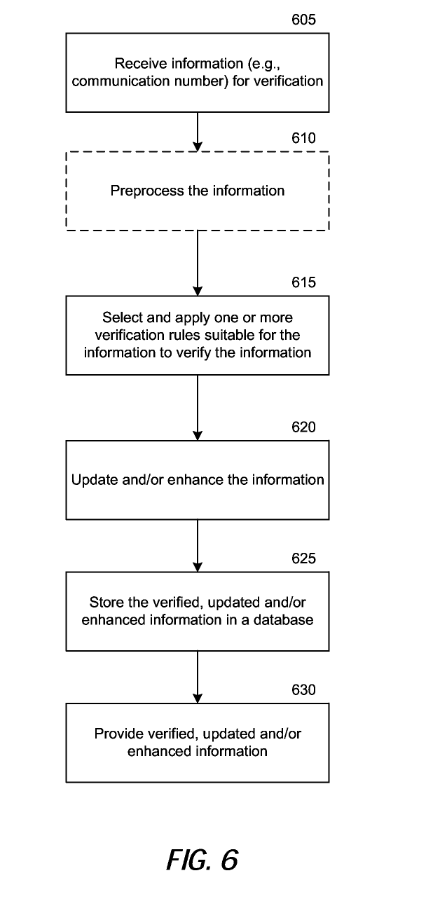

An example method for information verification based on verification rules is illustrated in FIG. 6. Starting at block 605, a communication number processing system receives information (e.g., a communication number) for verification. At block 610, the communication number processing system pre-processes the communication number. The pre-processing may be optional, and may be carried out when the communication number needs to be cleansed. The cleansing may be performed using one or more cleansing rules (e.g., via the communication number cleansing module 224). Alternatively, the pre-processing may be performed by other modules, or a combination of other modules, including the communication number verification module 226. At block 615, the communication number processing system selects and applies one or more verification rules suitable for the communication number to verify the communication number. For example, for a mobile communication number, a set of verification rules may be applicable, while for a VoIP communication number, a different set of verification rules may be applicable. Further, the verification rules for the mobile number or the VoIP number may be different from the verification rules for a fixed land line number. Alternately, verification rules may be devised to be applicable across a large number of communication number types. The communication number processing system may retrieve information relating to the communication number from one or more database tables, and/or from queries to the SS7 network, and evaluate the information using the applicable verification rules to verify the received information. For example, a communication number may be verified if it is valid or active and reachable. Similarly, a communication number (e.g., an online phone number such as Skype) may be verified if it is valid and an SMS/phone verification is successful. In an embodiment, the verification is performed without initiating an SMS or a phone call to the communication number. By way of another example, a communication number may be verified if the received information matches the information aggregated by the communication number processing system.

At block 620, the communication number processing system updates and/or enhances the received information (e.g., the communication number) with the retrieved information. For example, if the received information includes a name and a communication number, the communication number processing system updates and/or enhances the name and the communication number to include a cleansed version of the communication number, and additional verified information such as address, communication number type, current location, roaming status, service length, communication number status, and the like. At block 625, the communication number processing system stores the verification results and the updated and/or enhanced information in one or more database tables. Finally, at block 630, the communication number processing system provides the verification results, along with the updated and/or enhanced information to the client system.

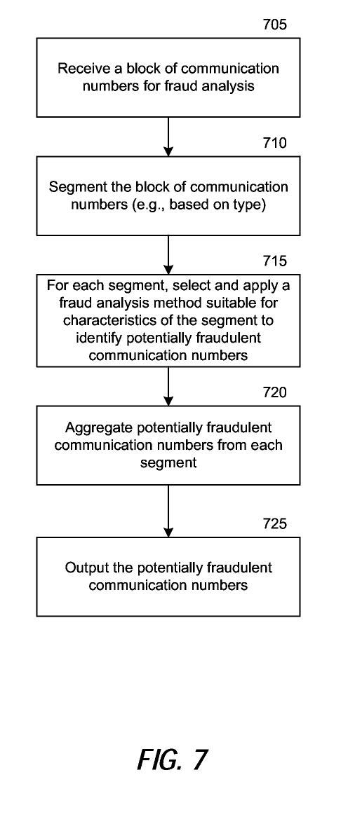

An example method of performing a fraud analysis on communication numbers is illustrated in FIG. 7. A communication number processing system (e.g., the communication number fraud analysis module 230) receives or retrieves a block of communication numbers for fraud analysis at block 705. In an embodiment, the communication number fraud analysis module 230 can receive or retrieve a block of communication numbers for fraud analysis from other modules of the communication number processing system. The fraud analysis may be initiated in response to a client request or in accordance with a schedule or watch list for periodically checking for fraud. At block 710, the communication number processing system segments the block of communication numbers into groups or classes based on a criterion such as a communication number type. For each segment, the communication number processing system selects and applies a fraud analysis method or criteria suitable for characteristics of the segment to identify potentially fraudulent communication numbers at block 715. For example, for fixed line phone numbers, the fraud analysis method may include verifying the name and address of a subscriber, type of service, length of service, and the like. For mobile phone numbers, the fraud analysis method may include determining roaming status, phone number type, reachability status, and the like. At block 720, the communication number processing system aggregates the potentially fraudulent communication numbers from each segment, and outputs the aggregated potentially fraudulent numbers to the client at block 725.

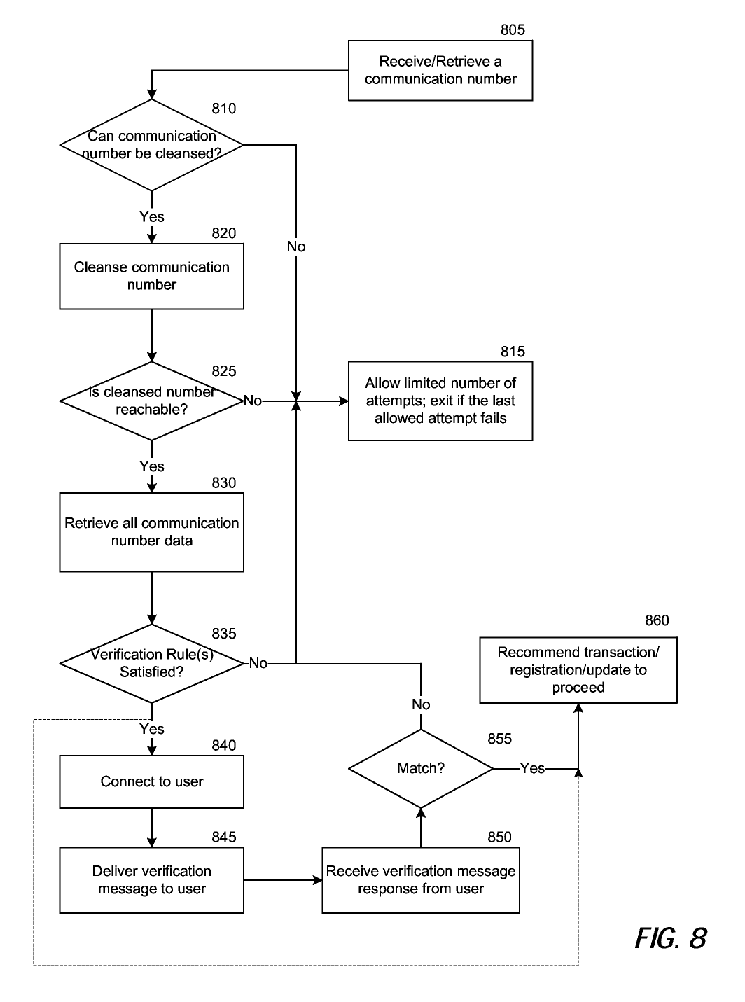

An example method of allowing or rejecting a transaction based on a communication number is illustrated in FIG. 8. The communication number processing may be incorporated in a process of a user registration, a transaction with or without a user login, and the like. In some implementations, one or more steps of the example method may be optional. For example, cleansing a communication number (blocks 810 and 820) can be optional. Similarly, if communication number data related to a communication number was recently retrieved, the retrieving step (block 830) can be optional. A communication number processing system receives or retrieves a communication number at block 805. The communication number may be received or retrieved either from an at least partially completed registration process, a transaction process, an authentication process, a verification process, or the like. At decision block 810, the communication number processing system determines if the communication number can be cleansed, based on one or more communication number cleansing rules (e.g., from the communication number cleansing rules table 255). If the communication number can be cleansed, the communication number processing system applies one or more communication number cleansing rules to cleanse the communication number at block 820. Alternately, the communication number processing system may attempt to cleanse the communication number a limited number of times at block 815. At block 825, the communication number processing system determines if the cleansed communication number is usable for further processing and initiating communication. If a communication number is reachable, then the communication number processing system is able to successfully communicate with the communication number. If the cleansed communication number is not usable or reachable, the communication number processing system attempts to determine the usability or reachability a limited number of times at block 815. When the maximum number of attempts is exhausted with no success, the method is terminated.

When the cleansed communication number is usable or reachable, then the communication number processing system retrieves some or all available data associated with the communication number at block 830. Data associated with the communication number may include a communication number type such as mobile, landline, non-fixed VoIP, invalid, pre-paid, personal, pager, toll-free, restricted, and the like; a communication number address comprising the address where the communication number was activated, the address where the communication number is registered, and the like, comprising a street number, street name, city, county (or the like), state (or the like), country, zip code (or the like), latitude, longitude, time zone, and the like; a communication number location comprising current geographic location of the communication number, and the like; a communication number status comprising subscriber status (active, disconnected, or the like), device status (reachable, unreachable, or the like), roaming status (roaming, not roaming, or the like), roaming country, and the like; a communication number reputation comprising number of correct/incorrect responses during a verification attempt, number of verification attempts, length of time between verification attempts, failed verification count, successful verification count, total verification count, transaction history, customer rating, history of changes to other data associated with the communication number, fraud level, date, time, reported fraudulent transaction history, other reported reputational data, and the like, and client information comprising client ID, client name, client address, billing, and the like. It will be appreciated by those in the art that a comparison of some, all, or other communication number information types with these or other criteria may be used as part of an assessment as to whether a verification action as part of a transaction, registration, or login attempt may be allowed.

Based on the data gathered at block 830, the communication number processing system determines whether the communication number information satisfies at least one verification rule at block 835. If no verification rules at block 835 are satisfied, a limited number of attempts are allowed at block 815. If the maximum number of attempts has occurred without success, the process is terminated. However, if at least one verification rule is satisfied, the communication number processing system connects to a user associated with the communication number at block 840. At block 845, the communication number processing system delivers a verification message to the communication number with a one time password (OTP) or other confirmatory information via a phone call, SMS message, push notification, an instant message or the like, which prompts the user to send a response to the verification message in a format defined by the verification message. The communication number processing system then receives the response to the verification message from the user at block 850. Once the response is received from the user, it is compared with the requested information to determine a match at block 855. If no match is found, a limited number of attempts are allowed at block 815. If the maximum number of attempts has occurred without success, the process is terminated. In the event that there is a match, the communication number processing system recommends or allows a transaction, registration, authentication, or the like to proceed at block 860. Alternatively, connecting the user via the communication (block 840) may be optional and may be skipped entirely. When one or more verification rules are satisfied as determined at decision block 835, the communication number processing system can recommend the transaction, registration, authentication, update or the like to proceed (block 860).

In addition to a transaction, registration, authentication, request for privilege escalation or the like, the method illustrated in FIG. 8 and/or other verification and fraud analysis methods disclosed throughout the present disclosure may be used in various other applications. For example, the example method illustrated in FIG. 8 may be used by the communication number processing system when updating records relating to users of a client system (e.g., a website). Records may be updated when a user makes any changes to any informational field, including a communication number. The record change may be allowed only upon generating a successful match.

In some embodiments, the method illustrated in FIG. 8 may be triggered when new indicia of fraud and/or rules are available, when new/change in fraud patterns are detected and/or when existing indicia of fraud and/or rules are modified. These additions or modifications can trigger re-cleansing of communication numbers using new or updated cleansing rules, verification using new or updated verification rules, updated fraud analysis and the like.

### 4. CONCLUSION

Those skilled in the art will appreciate that the actual implementation of a data store may take a variety of forms, and the phrase “data store” is used herein in the generic sense to refer to any area that allows data to be stored in a structured and accessible fashion using such applications or constructs as databases, tables, linked lists, arrays, and so on.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative combinations or subcombinations. Each of these processes or blocks may be implemented in a variety of different ways. Also, while processes or blocks are at times shown as being performed in series, these processes or blocks may instead be performed or implemented in parallel, or may be performed at different times.

In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

1. A processor-implemented method for assessing risk associated with a termination point identifier, comprising:
receiving a termination point identifier that is to be assessed for risk;
receiving device attributes, location attributes and network-derived characteristics of the termination point identifier;
evaluating, by a processor, the device attributes of the termination point identifier, location attributes of the termination point identifier, and network-derived characteristics of the termination point identifier using one or more rules, wherein each of the device attributes, location attributes, and network-derived characteristics of the termination point identifier is associated with a corresponding weight;
generating, by the processor, a score for the termination point identifier based on the evaluation and the weights associated with the device attributes, location attributes, and network-derived characteristics, wherein the score provides an assessment of risk associated with the termination point identifier; and
granting, denying or challenging, by the processor, a transaction request of a user associated with the termination point identifier based on evaluation of the score using one or more rules.

2. The method of claim 1, wherein the network-derived characteristics include a type of service associated with the termination point identifier and a length of the service.

3. The method of claim 1, wherein the device attributes of the termination point identifier include a provider or carrier name, type of termination point identifier or an address associated with the termination point identifier; and wherein the location attributes of the termination point identifier include a current or past location of a device associated with the termination point identifier.

4. The method of claim 1, further comprising:
receiving client reporting characteristics, wherein the client reporting characteristics is also associated with a corresponding weight and is evaluated along with the device attributes, location attributes, and network-derived characteristics to generate the score for the termination point identifier.

5. The method of claim 1, wherein behavioral characteristics having a corresponding weight is also evaluated along with the device attributes, location attributes, and network-derived characteristics to generate the score for the termination point identifier.

6. The method of claim 1, further comprising:
detecting a new pattern of fraud based on analyzing at least one of:
feedback identifying fraudulent termination point identifiers or results from verification of multiple termination point identifiers; and
in response to detecting the new pattern of fraud, updating the one or more rules for evaluating the device attributes, location attributes, and network-derived characteristics.

7. The method of claim 1, further comprising:
detecting a new pattern of fraud based on analyzing at least one of: feedback identifying fraudulent termination point identifiers or results from verification of multiple termination point identifiers, and, in response to detecting the new pattern of fraud,
identifying at least one other category of information, wherein the at least one other category of information is considered in addition to or instead of one or more of the device attributes, location attributes or network-derived characteristics in assessing risk of fraud associated with a subsequent termination point identifier.

8. The method of claim 1, wherein at least the device attributes, location attributes, and network-derived characteristics are evaluated using the one or more rules for the presence of one or more indicia of fraud.

9. The method of claim 1, wherein the termination point identifier is at least one of: a mobile phone number, a pre-paid mobile phone number, a landline telephone number, a voice over Internet Protocol (VoIP) phone number or a pay phone number.

10. (canceled)

11. (canceled)

12. The method of claim 1, wherein the transaction request includes a user authentication request, a user account registration request or a user request to change a termination point identifier, password reset, or another setting associated with an account.

13. The method of claim 1, further comprising:
cleansing the termination point identifier using one or more cleansing rules to render the termination point identifier dialable and traceable;
using the cleansed termination point identifier to retrieve the device attribute, location attributes, and network-derived characteristics.

14.-20. (canceled)

21.-30. (canceled)

31. A system for assessing risk associated with a termination point identifier, comprising:
a memory storing computer-executable instructions:
a module that receives a termination point identifier that is to be assessed for risk;
a module that evaluates device attributes of the termination point identifier, location attributes of the termination point identifier, and network-derived characteristics of the termination point identifier using one or more rules, wherein each of the device attributes, location attributes, and network-derived characteristics of the termination point identifier is associated with a corresponding weight;
a module that generates a score for the termination point identifier based on the evaluation and the weights associated with the device attributes, location attributes, and network-derived characteristics, wherein the score provides an assessment of risk associated with the termination point identifier; and
a processor for executing the computer-executable instructions stored in the memory.

32. The system of claim 31, wherein the network-derived characteristics include date of activation of the termination point identifier and type of service attached to the termination point identifier.

33. The system of claim 31, wherein the device attributes of the termination point identifier include a provider or carrier name, type of termination point identifier or an address associated with the termination point identifier; and wherein the location attributes of the termination point identifier include a current or past location of a device associated with the termination point identifier.

34. The system of claim 31, wherein the memory further stores computer-executable instructions of:
a module that receives behavioral characteristics associated with a user of the termination point identifier; and
a module that receives client reporting characteristics, the behavioral characteristics and the client reporting characteristics each having a corresponding weight.

35. The system of claim 34, wherein at least one of the client reporting characteristics or the behavioral characteristics is evaluated along with the device attributes, location attributes, and network-derived characteristics to generate the score for the termination point identifier.

36. The system of claim 31, wherein at least the device attributes, location attributes, and network-derived characteristics are evaluated using the one or more rules for the presence of one or more indicia of fraud.

37. The system of claim 36, wherein the memory further stores computer-executable instructions of:
a module that detects a new pattern of fraud based on analyzing feedback identifying fraudulent termination point identifiers or results from verification of multiple termination point identifiers; and
a module that updates the one or more rules for evaluating the device attributes, location attributes, and network-derived characteristics such that the generated score reflects the new pattern of fraud.

38. The system of claim 31, wherein the termination point identifier is at least one of: a mobile phone number, a pre-paid mobile phone number, a landline telephone number, a voice over Internet Protocol (VoIP) phone number or a pay phone number.

39. The system claim 31, where the memory further stores computer-executable instructions of:
a module that generates a recommendation regarding a transaction of a user associated with the termination point identifier based on the generated score and one or more rules for evaluating the score.

40. (canceled)
